(19) United States
(12) Patent Application Publication
(10) Pub. No.: US 2004/0170350 A1
(43) Pub. Date: Sep. 2, 2004

(54) Resiliently mounted bearing

(76) Inventors: Steven Murray McCallum, Christchurch (NZ); William Alexander Wright, Kaiapoi (NZ)

Correspondence Address: McCormick Paulding & Huber, City Place II, 185 Asylum Street, Hartford, CT, 06103-4102, US

(21) Appl. No.: 10/477,249

(22) PCT Filed: May 15, 2002
(86) PCT No.: PCT/NZ02/00095

(30) Foreign Application Priority Data
May 15, 2001 (NZ) 511741

(51) Int. Cl. F16C 27/00

(52) U.S. Cl. 384/536

(57) ABSTRACT

An improved bearing assembly (5) especially suitable for supporting a rotating shaft (2) or similar component which is subjected to a symmetrical or irregular loading; the bearing assembly (5) includes at least two coaxial rolling type bearings (6, 7) each of which is provided with one or more mounting seals (9, 10); each seal (9, 10) is a ring of resilient material arranged to contact the external circumference of the bearing (6, 7) so that each bearing (6, 7) is mounted upon the corresponding seal or seals (9, 10).

### TECHNICAL FIELD

The present invention relates to an improved bearing assembly for supporting a rotating shaft or similar elongated component. The present invention also relates to an electric motor incorporating this bearing assembly.

The bearing assembly of the present invention is particularly suitable for use as a shaft bearing for small electric motors which in use are under an irregular and/or asymmetrical load, and therefore will be described with especial reference to this application. However, it will be appreciated that the bearing assembly of the present invention is suitable for any application where a rotating shaft or similar elongated component requires bearing support. Thus, the bearing assembly of the present invention also is suitable for larger scale applications and/or applications where the shaft loading is constant.

A shaft which is under an intermittent and/or asymmetrical load tends to cause unduly rapid wear of the supporting bearings. Obviously, this problem can be overcome by making the bearing larger and stronger, but the solution is not available if the size of the bearing is limited as, for example in the case of a small electric motor in applications where a compact size and shape are essential.

If a shaft under an intermittent and/or asymmetrical load is supported by porous metal bearings (e.g. sintered metal bearings) the necessary clearance between the shaft and the bearing accentuates the movement of the shaft under an asymmetrical or irregular load, and leads to heating and rapid wear of the bearing and in some cases to the shaft precessing round the bearing.

If a rolling type bearing is substituted for a porous bearing in an attempt to overcome the above described problems, the asymmetrical/irregular load causes the bearing to wear unevenly, and the bearings tend to be very noisy in operation.

As used herein, the term “rolling type bearing” refers to any bearing with an outer race which provides containment for rolling components (e.g. balls, rollers), and may be formed with or without an inner race. The term includes ball bearings, roller bearings, needle roller bearings and any variation or combination of these.

### BACKGROUND ART

There have been a number of prior proposals for cushioning bearings by mounting them in one or more resilient supports; for example U.S. Pat. No. 2,114,670 discloses a pillow block in which a bearing such as a ball bearing is mounted in a housing with a pair of rings 14 which fit into channels 13/9 formed respectively in the outer ring of the bearing and in the housing.

Similarly, JP 10299 785-A. shows a bearing in which a rotor shaft 5 is mounted in a housing 6 by means of the bearing formed with grooves 8 on its outer surface; flexible material 9 is press fitted into the grooves to hold the bearing securely in the housing.

DE 383-4271 shows a shaft support bearing very similar to JP 10299 785-A, consisting of a single bearing 16 supporting a shaft, with the outer race 20 of the bearing support held in a spacing ring 22 by means of a pair of elastomeric rings 30, 32 sprung into grooves in the outer race 20.

However, all of the above described configurations show bearings in which the outer race has to be shaped or grooved in some way to receive the flexible or resilient material supporting the bearing:—this has the drawback that a standard bearing cannot be used, since the outer race of a standard bearing is smooth, not grooved. The need to use a specially designed bearing considerably increases the cost of the design.

It should be noted that none of the above described configurations is designed for applications where the shaft load is irregular and/or asymmetrical. In particular, it is noteworthy that in all of the above described configurations, the shaft is supported only by a single bearing:—tests carried out by the present inventors have shown that in practice, this is inadequate where the shaft is under an irregular or asymmetrical load.

It is therefore an object of the present invention to provide a bearing assembly which overcomes the above described drawbacks, and provides a bearing assembly capable of accepting irregular and/or asymmetrical loading without an increase in the size of the bearing, but with a satisfactory bearing life.

### DISCLOSURE OF INVENTION

The present invention provides a bearing assembly which includes at least two coaxial rolling type bearings, each bearing being provided with at least one mounting seal, each seal comprising a ring of resilient material which is arranged to contact the external circumference of the corresponding bearing such that in use each bearing is mounted upon the corresponding seal or seals.

Preferably, each bearing is provided with at least two spaced, substantially parallel mounting seals. The number of mounting seals which support each bearing depends upon the length of the external housing of the bearing:—for longer bearings, three or more seals may be used.

The coaxial rolling type bearings may be mounted side by side in the assembly or may be spaced apart.

The present invention further provides an electric motor which includes a shaft supported by the above described bearing assembly. Preferably, the electric motor also includes a pair of substantially identical end caps arranged one over each end of the motor and anchoring means for securing said end caps to said motor.

In one embodiment of the invention, said anchoring means comprise a pair of anchoring clips, one anchoring clip being arranged as a snap fit over one side of the motor field winding, and the other anchoring clip being arranged as a snap fit over the other side of the field winding; each said anchoring clip providing securing means at each end thereof to which the respective end caps may be releasably secured.

### BRIEF DESCRIPTION OF DRAWINGS

By way of example only, preferred embodiments of the present invention are described in detail with reference to the accompanying drawings, in which:-

FIG. 1 is a cross-section through a bearing in accordance with the present invention;

FIGS. 2 and 3 respectively are a plan view and a side view of the anchoring clip of the present invention; and

FIG. 4 is an exploded side view of a field winding with the anchoring clips in place, and a single end cap.

### BEST MODE FOR CARRYING OUT THE INVENTION

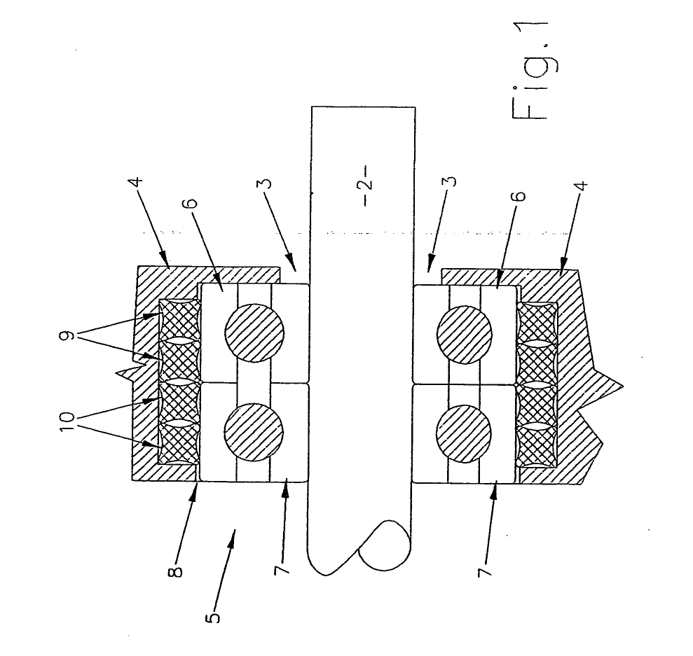

Referring to FIG. 1, a shaft 2 is shown passing through an aperture 3 in a housing 4, with the shaft 2 mounted in a bearing assembly 5 in the aperture 3. The bearing assembly 5 consists of a pair of conventional roller bearings 6,7 coaxially mounted side by side in a recess 8 formed in the housing 4.

Each bearing 6,7 may be any rolling type bearing suitable for the shaft dimensions and loading. Each bearing 6,7 has a smooth outer surface.

The bearings 6,7 are shown side by side and in contact with each other, but may if preferred be spaced apart in the recess 8 or may be mounted in separate recesses in the housing, if space permits.

Each bearing 6,7 is mounted in the recess 8 supported upon a pair of parallel seals 9,10 respectively. The inner surface of each seal 9,10 is in firm, resilient contact with the outer surface of the corresponding bearing, and the outer surface of each seal 9,10 contacts the inner surface of the housing 8. Each seal 9,10 may be a ring of any suitable resilient material e.g. a conventional neoprene ring seal.

Each bearing 6,7 may be mounted only upon a single seal or may be mounted upon two, three or more seals, depending upon the length of the bearing.

Further, more than two bearings, each supported by at least one seal, may be used if space permits.

It has been found that a bearing assembly of the above described type is capable of excellent service even when irregular and/or asymmetrical loads are placed on shaft 2. The bearing assembly performs under test substantially better than a single bearing of comparable size, for reasons which are not fully understood.

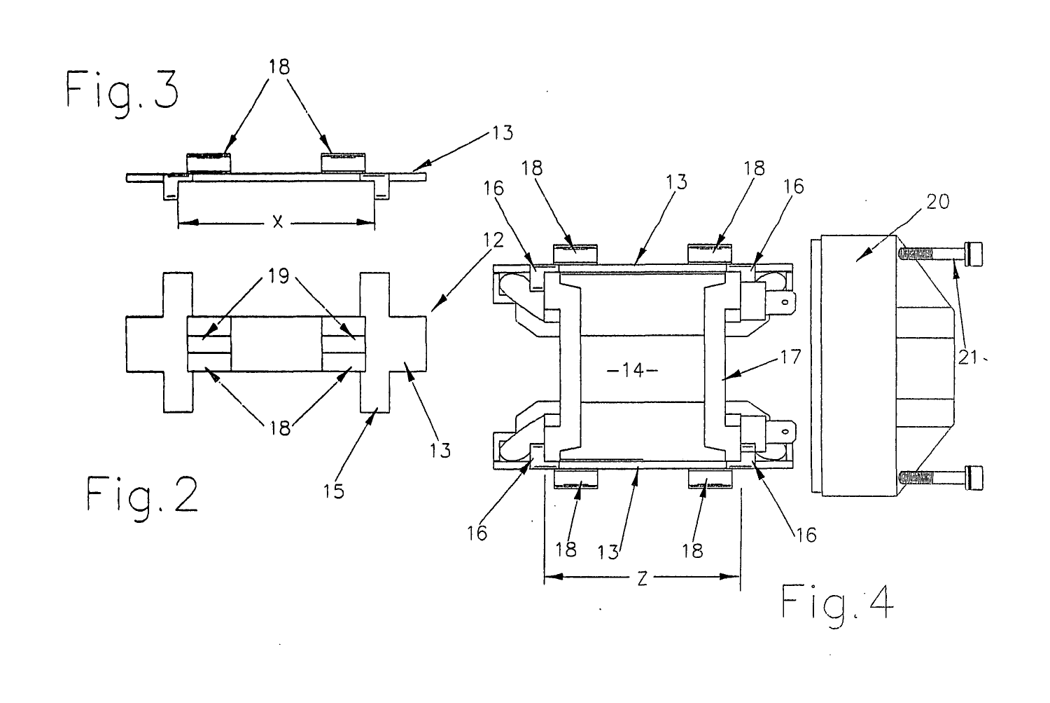

Referring now to FIGS. 2-4, an anchoring clip 12 is made of a tough, resilient non electrically conducting material e.g. a suitable plastics material. The clip 12 consists of a plate 13 of approximately the same length as a field winding 14; the plate 13 is formed with a crosspiece 15 adjacent each end. The outer end of each crosspiece 15 is formed with a short flange 16 which extends at right angles to the plane of the plate 13; the spacing x between the inner surfaces of the flanges 16 is slightly less than the length z of the field winding mounting 17, so that each clip 12 can be snap fitted over the field winding mounting 17.

Each plate 13 is formed with a pair of thickened portions 18 adjacent the crosspieces 15. Each portion 18 is formed with a screw threaded aperture 19 for receiving a screw passing through a corresponding aperture in an end cap (not shown).

In use, anchoring clips 12 are snap fitted over two opposite sides of the field winding mounting 17, and motor end caps 20 are screwed onto the anchoring clips by screws 21 passing through the end caps 20 and into the corresponding apertures 19. Only a single end cap 20 is shown in FIG. 4; the other end cap is secured to the other end of the anchoring clips 12 in the same manner. The central portion of the motor housing is formed from a tube (not shown) fitted between the end caps 20.

The use of anchoring clips and end caps as described above gives a particularly rapid and secure method for assembling the motor. Further, a motor assembled in this way can be easily and quickly disassembled for inspection or maintenance. The end caps 20 are identical; this further reduces the cost of manufacturing and assembling the motor.

In a variation of the above-described arrangement, each anchoring clip may be replaced by any suitable device for securing the end caps.

The above described electric motor may be used in combination with the bearing described with reference to FIG. 1, i.e. the shaft 2 may be the shaft of the electric motor. The use of a bearing in accordance with the present invention in combination with the electric motor gives a particularly advantageous electric motor:—the shaft can not only cope with an irregular and/or a symmetrical load without undue wear, but also the bearing presents so little friction to the rotation of the shaft that the motor can be used successfully at very low voltages:—it has been found that an electric motor of this type is suitable for use with voltages of 240 or 120 ac or as low as 50V dc.

1. A bearing assembly which includes at least two coaxial rolling type bearings, each bearing being provided with at least one mounting seal, each seal comprising a ring of resilient material which is arranged to contact the external circumference of the corresponding bearing such that in use each bearing is mounted upon the corresponding seal or seals.

2. The bearing assembly as claimed in claim 1, wherein each bearing is provided with at least two spaced, substantially parallel mounting seals.

3. The bearing assembly as claimed in claim 1 or claim 2 wherein said rolling type bearings are mounted side by side.

4. The bearing assembly as claimed in claim 1 or claim 2 wherein said rolling type bearings are spaced apart.

5. The bearing assembly as claimed in any one of claims 1-4, wherein the external circumference of each bearing is smooth.

6. An electric motor which includes a shaft supported by the bearing assembly as claimed in any one of claims 1-5.

7. The motor as claimed in claim 6 further includes a pair of substantially identical end caps arranged one over each end of the motor and anchoring means for securing said end caps to said motor.

8. The motor as claimed in claim 7 wherein said anchoring means comprise a pair of anchoring clips, one anchoring clip being arranged as a snap fit over one side of the motor field winding, and the other anchoring clip being arranged as a snap fit over the other side of the field winding; each said anchoring clip providing securing means at each end thereof to which the respective end caps may be releasably secured.
